(19) United States
(12) Patent Application Publication
(10) Pub. No.: US 2008/0179798 A1
(43) Pub. Date: Jul. 31, 2008

(54) Fluid filled type engine mount

(75) Inventors: Akio Saiki, Komaki-shi (JP); Takayoshi Yasuda, Iwakura-shi (JP); Yuichi Ogawa, Kasugai-shi (JP)

Correspondence Address: OLIFF & BERRIDGE, PLC, P.O. BOX 320850, ALEXANDRIA, VA, 22320-4850, US

(73) Assignee: TOKAI RUBBER INDUSTRIES, LTD., KOMAKI-SHI (JP)

(21) Appl. No.: 12/010,161

(22) Filed: Jan. 22, 2008

(30) Foreign Application Priority Data
Jan. 25, 2007 (JP) 2007-015433
Sep. 21, 2007 (JP) 2007-246108

(51) Int. Cl. F16F 13/00

(52) U.S. Cl. 267/140.14

(57) ABSTRACT

A fluid filled type engine mount wherein a partition member is furnished with a valve housing zone and a valve body composed of ferromagnetic material is housed displaceably within the valve housing zone. An urging member is provided for urging the valve body towards a displacing end situated towards an equilibrium chamber. A valve member includes a coil disposed about the valve body in the partition member and energizing the coil to urge the valve body towards a pressure receiving chamber in opposition to urging force in order to place a second orifice passage in a cutoff state through by the urging force of the urging member, and in a communicating state through energization of the coil to separate contacting portions of the valve body and a wall of the valve housing zone.

### INCORPORATED BY REFERENCE

The disclosure of Japanese Patent Application No. 2007-015433 filed on Jan. 25, 2007 and No. 2007-246108 filed on Sep. 21, 2007, each including the specification, drawings and abstract is incorporated herein by reference in its entirety.

### BACKGROUND OF THE INVENTION

1. Field of the Invention

The present invention relates to an engine mount for vibration damping support of a power unit onto a vehicle body, and relates in particular to a fluid filled type engine mount that exhibits vibration damping action on the basis of the flow behavior of a fluid filled in the interior thereof.

2. Description of the Related Art

One kind of fluid filled type engine mount known in the past as engine mount for an automobile or the like typically includes a first mounting member and a second mounting member mounted respectively on the power unit and vehicle body and linked to each other by a main rubber elastic body. The engine mount also includes therein a pressure receiving chamber whose wall is partially constituted by the main rubber elastic body, and an equilibrium chamber whose wall is partially constituted by a readily deforming, flexible film, with the pressure receiving chamber and the equilibrium chamber having a non-compressible fluid filled therein, and with the two chambers connected to each other by an orifice passage. Fluid filled type engine mounts of this kind exhibit outstanding vibration damping action through utilization of the flow behavior, such as the resonance behavior, of fluid induced to flow through the orifice passage.

Since vibration of different frequencies will be input depending on driving conditions and the like, it is preferable for an engine mount to be able to exhibit effective vibration damping action against vibration at a number of different frequencies. However, a problem is that frequencies damped effectively on the basis of the flow behavior of fluid induced to flow through the orifice passage is limited to a relatively narrow frequency band to which the orifice passage has been tuned in advance.

To address this problem, there has been proposed, for example in U.S. Pat. No. 4,610,421, a fluid filled type engine mount which has respectively formed therein a first orifice passage and a second orifice passage connecting the pressure receiving chamber and the equilibrium chamber, with the first orifice passage being tuned to a higher frequency than the second orifice passage, and which is switched between the first and second orifice passages by a valve body actuated and displaced by the action of a magnetic field generated by energizing a coil. With this structure, by controlling energizing of the coil according to driving conditions and so on, it is possible to achieve effective vibration damping action against both engine shake which poses a problem during driving, and idling vibration which poses a problem when the vehicle is at a stop.

However, research conducted by the inventors has shown that the engine mount taught in U.S. Pat. No. 4,610,421 still has room for improvement.

Specifically, the engine mount disclosed in U.S. Pat. No. 4,610,421 is designed so that when the second orifice passage is to be blocked off during driving, the coil is energized by an external power supply; and when the second orifice passage is to be opened up with the vehicle at a stop, energizing of the coil is suspended, whereupon the second orifice passage is placed in the communicating state by the urging force of a coil spring.

With this kind of energization control, it is necessary to energize the coil for the longer periods for which it is used during driving, and thus the duration of energization of the coil is extended, and power consumption becomes considerable. This may have caused problems such as adverse effects on mileage.

Moreover, with fluid filled type vibration damping devices having fluid filled in the interior designed so that the actuating force for the valve is provided by energizing a coil, it was necessary to mount the coil on the outside of the vibration damping device in order to avoid problems such as electrical leakage during energization of the coil. For this reason, a fluid filled type vibration damping of sufficiently compact size has yet to be achieved.

To address the problems inherent in the engine mount disclosed in U.S. Pat. No. 4,610,421, there has been proposed, for example in U.S. Pat. No. 6,921,067 a structure whereby the second orifice passage is switched to the communicating state when the coil is energized.

However, the fluid filled type engine mount disclosed in U.S. Pat. No. 6,921,067 has the following three inherent problems. The first problem is that since the valve member for opening/closing the second orifice passage spreads outwardly in a flanged shape from the center of the mounting, the valve member requires a large installation space, making the mounting per se large in the axis-perpendicular direction. The second problem is that since the valve member and the coil spring which urges it are juxtaposed in-line on the center axis of the mounting, they require a large installation space, making the mounting per se large in the axial direction. The third problem is that the design has no reducing action whatsoever in relation to noise caused by cavitation, which arises when excessive negative pressure is created in the pressure receiving chamber during input of a large impact load.

### SUMMARY OF THE INVENTION

It is an object of the present invention to provide a fluid filled type engine mount of novel structure, furnished with a valve member for selective functioning of the first and second orifice passages with a minimum of power consumption, and affording effective vibration damping action against vibration of two different frequency bands, without any appreciable increase in size of the mounting.

The above and/or optional objects of this invention may be attained according to at least one of the following modes of the invention. The following modes and/or elements employed in each mode of the invention may be adopted at any possible optional combinations. It is to be understood that the principle of the invention is not limited to these modes of the invention and combinations of the technical features, but may otherwise be recognized based on the teachings of the present invention disclosed in the entire specification and drawings or that may be recognized by those skilled in the art in the light of the present disclosure in its entirety.

One aspect of the present invention provides a fluid filled type engine mount comprising: a fluid filled type engine mount comprising: a first mounting member fixable to one of a power unit and a vehicle body; a second mounting member mounted on an other of the power unit and the vehicle body; a main rubber elastic body elastically connecting the first mounting member and the second mounting member; a partition member supported by the second mounting member; a pressure receiving chamber whose wall is partially constituted by the main rubber elastic body and having a non-compressible fluid filled therein; an equilibrium chamber whose wall is partially constituted by a readily deforming, flexible film and having the non-compressible fluid filled therein, the chambers being formed respectively to either side of the partition member; a first orifice passage and a second orifice passage respectively connecting the pressure receiving chamber and the equilibrium chamber to each other, with the second orifice passage being tuned to a higher frequency band than the first orifice passage; and valve means or a valve member actuated by energization from an outside, with the second orifice passage being switchable between a communicating state and a cutoff state by the valve means, wherein the partition member is furnished with a valve housing zone along a fluid passage through the second orifice passage, and a valve body composed of ferromagnetic material is housed displaceably within the valve housing zone; urging means or an urging member is provided for urging the valve body towards a displacing end situated towards the equilibrium chamber; the valve means includes a coil disposed about the valve body in the partition member and energizing the coil to urge the valve body towards the pressure receiving chamber in opposition to urging force; communication holes are formed respectively at mutually non-overlapping locations in contacting portions of the valve body and a wall of the valve housing zone urged into contact with one another by the urging force of the urging means; and the second orifice passage is placed in the cutoff state through juxtaposition of the contacting portions of the valve body and the wall of the valve housing zone by the urging force of the urging means, blocking off the communication holes, while the second orifice passage is placed in the communicating state through energization of the coil to separate the contacting portions of the valve body and the wall of the valve housing zone, unblocking the communication holes.

In the fluid filled type engine mount constructed according to the present invention, communication holes are formed respectively on the juxtaposed faces of the valve body and the wall of the valve housing zone in the direction of movement of the valve body thereby constituting a flow passage that places the second orifice passage in the communicating state. The two communication holes are placed in the non-communicating state by juxtaposition of the valve body against the wall of the valve housing zone, placing the second orifice passage in the cutoff state.

In this way, a fluid passage in the valve means for opening/closing the second orifice passage is constituted by communication holes formed to open towards the direction of extension of the second orifice passage coincident with the direction of movement of the valve body, whereby it is possible for the fluid passage to be formed in the partition member so as to extend in the direction of opposition of the locations of the pressure receiving chamber and the equilibrium chamber, i.e. in the direction of the mounting center axis. It is accordingly possible to achieve valve means for opening/closing the second orifice passage without any increase in the size of the mounting in the axis-perpendicular direction such as is entailed with the valve member of conventional structure taught in U.S. Pat. No. 6,921,067, so as to maintain a compact mounting size.

Moreover, in the fluid filled type engine mount pertaining to the present invention, there may be employed a structure wherein the valve body has a bottomed circular cylinder shape, with the floor of the valve body constituting the contacting portion positioned in contact against the wall of the valve housing zone, and with the communication hole formed in the floor of the valve body. With this structure, the peripheral wall of the valve body will be formed so as to extend in the direction of displacement, and the stability of displacement of the valve body will be improved on the basis of guiding action of the valve body peripheral wall by the peripheral wall of the valve housing zone.

Preferably, in the fluid filled type engine mount pertaining to the present invention, there may be employed a structure wherein a coil spring is employed as the urging means, with the coil spring positioned with one end thereof inserted within the peripheral wall of the valve body and positioned in contact with the floor of the valve body. With this structure, positioning of the coil spring on the valve body can be accomplished through a simple structure, and also the coil spring will afford positioning of the valve body in the axis-perpendicular direction. Furthermore, since the coil spring is disposed inside the valve body, space for installation of the coil spring can be ensured advantageously, without limiting valve body size in the axial direction.

Moreover, in the fluid filled type engine mount pertaining to the present invention, there may be employed a structure wherein the communication hole in the contacting portion of the valve body and the communication hole in the contacting portion of the wall of the valve housing zone are disposed at mutually different locations in a direction orthogonal to the direction of contact of the valve body with the wall of the valve housing zone. With this structure, during assembly of the valve body into the valve housing zone, it will be possible to set the communication holes in the two members at different locations in the juxtaposed state, without having to align their positions in the circumferential direction of the valve body.

Moreover, in the fluid filled type engine mount pertaining to the present invention, there may be employed a structure wherein the pressure of the pressure receiving chamber is exerted on one face of the valve body, while the pressure of the equilibrium chamber is exerted on the other face of the valve body through the communication hole provided in the wall of the valve housing zone, so that during input of vibration the negative pressure generated in the pressure receiving chamber thereby will urge the valve body in opposition to the urging force of the urging means to move it away from the wall of the valve housing zone and place the communication holes in the communicating state. With this structure, excessive negative pressure generated during input of a large impact load can be avoided or alleviated through the opening action of the valve body in association with the negative pressure, thereby making it possible to minimize occurrence of noise and vibration caused by cavitation of the pressure receiving chamber, and to do so without any increase of the number of specialized parts or making the structure more complicated.

Moreover, in the fluid filled type engine mount pertaining to the present invention, there may be employed a structure wherein the first orifice passage is tuned to a frequency band which corresponds to engine shake, and the second orifice passage is tuned to a frequency band which corresponds to idling vibration, thereby producing an engine mount for an automobile. With this structure, it is possible for low-frequency vibration corresponding to engine shake which tends to be problem when the car is driven, and medium- and high-frequency vibration corresponding to idling vibration which tends to be problem when the car is at a stop, to be effectively alleviated respectively by means of resonance or other flow behavior of fluid induced to flow through the first orifice passage and the second orifice passage.

### BRIEF DESCRIPTION OF THE DRAWINGS

The foregoing and/or other objects features and advantages of the invention will become more apparent from the following description of a preferred embodiment with reference to the accompanying drawings in which like reference numerals designate like elements and wherein:

FIG. 1 is a vertical cross sectional view of a fluid filled type automotive engine mount according to a first embodiment of the present invention, wherein it is in a non-energized state;

FIG. 2 is a vertical cross sectional view of the fluid filled type automotive engine mount of FIG. 1, wherein it is in an energized state; and

FIG. 3 is a vertical cross sectional view of a fluid filled type automotive engine mount according to a second embodiment of the present invention.

### DETAILED DESCRIPTION OF PREFERRED EMBODIMENTS

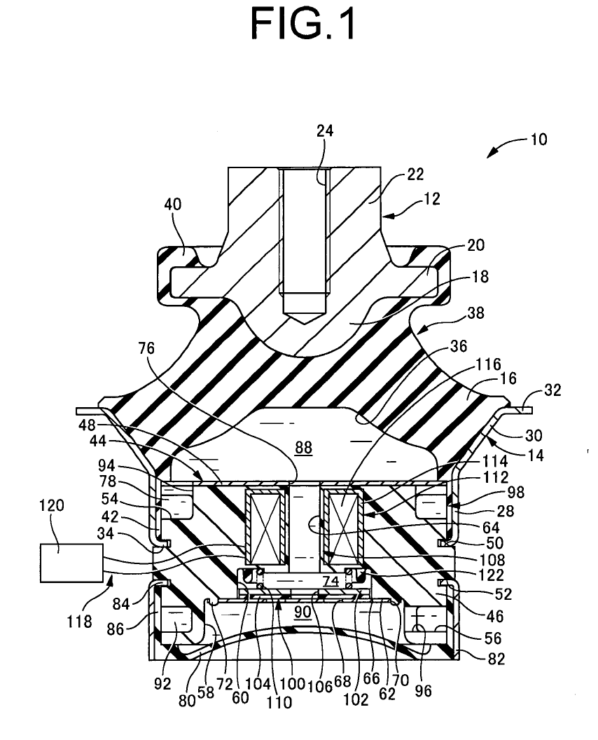

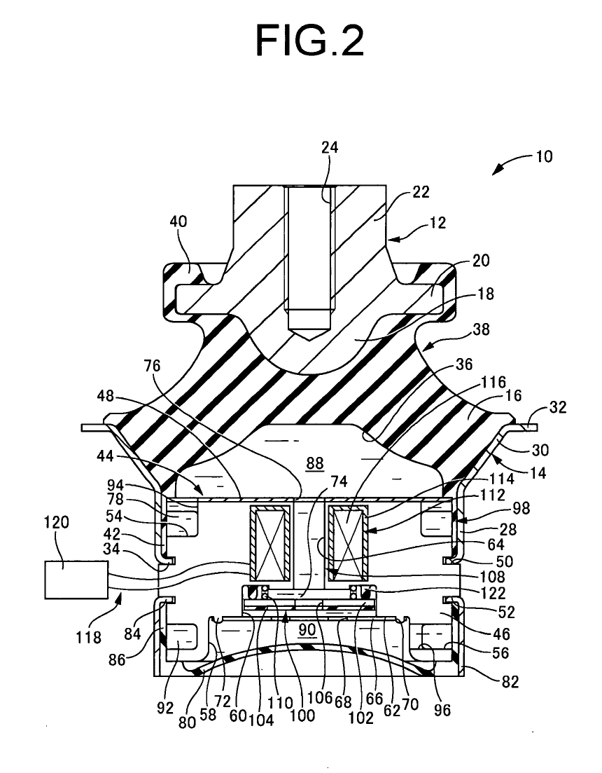

Referring first to FIGS. 1 and 2, there is shown an automotive engine mount 10 of fluid filled type engine mount according to a first embodiment of the present invention. This engine mount 10 has a structure wherein a first mounting member, namely a first mounting fitting 12, and a second mounting member, namely a second mounting fitting 14, are linked by a main rubber elastic body 16. The first mounting fitting 12 is attached to the power unit of the automobile (not shown) and the second mounting fitting 14 is attached to the body of the automobile (not shown). The power unit is thereby resiliently supported on the vehicle body via the engine mount 10. In the description hereinbelow, unless indicated otherwise, vertical direction refers to the vertical direction in FIG. 1, which represents the principal load input direction.

To describe in more detail, the first mounting fitting 12 is a rigid member fabricated of iron, aluminum alloy or the like having a generally circular block shape overall. The first mounting fitting 12 is also provided with a fastener portion 18 of generally semispherical shape convex downwardly in the axial direction. Furthermore, a stopper portion 20 is integrally formed on the upper end of the fastener portion 18 and extends outwardly in the axis-perpendicular direction about the entire circumference. Also, a thread portion 22 of generally circular post shape is integrally formed extending in the axial direction above the stopper portion 20. In the thread portion 22 there is formed a bolt hole 24 extending along the center axis; a fastening bolt (not shown) is threaded into the bolt hole 24 in order to fixedly mount the first mounting fitting 12 onto a member on the power unit side (not shown).

The second mounting fitting 14 has a thin-walled, large-diameter, generally circular cylinder shape overall, and is formed by a rigid member of iron, aluminum alloy, or similar material. The second mounting fitting 14 in the portion thereof below its axial medial section is constituted as a cylindrical section 28 that projects in the axial direction with generally unchanging diameter; and in the portion above the axial medial section is constituted as a tapered section 30 that flares out gradually going upward in the axial direction. Furthermore, a flange portion 32 that extends outwardly in the axis-perpendicular direction is integrally formed at the upper end of the tapered section 30. Also, at the axial lower end of the second mounting fitting 14 there is formed a first mating projection 34 of annular shape projecting inwardly in the diametrical direction and extending continuously about the entire circumference. A bracket (not shown) is fastened externally to the second mounting fitting 14, for example. The second mounting fitting 14 is fixedly mounted to the vehicle body side by fixedly mounting the bracket onto a component on the vehicle body side (not shown).

The first mounting fitting 12 and the second mounting fitting 14 are disposed coaxially with one another, and with the first mounting fitting 12 positioned axially above and spaced apart from the upper opening of the second mounting fitting 14. The main rubber elastic body 16 is interposed between the first mounting fitting 12 and the second mounting fitting 14. The main rubber elastic body 16 is a thick rubber elastic body of generally frustoconical shape overall, having formed in the center portion of its lower end a circular recess 36 that opens downward in the axial direction.

The fastener portion 18 of the first mounting fitting 12 is vulcanization bonded so as to be embedded in the axial upper end of the main rubber elastic body 16, and the stopper portion 20 is vulcanization bonded with its diametrical center portion juxtaposed against the upper face of the main rubber elastic body 16 from above in the axial direction, thereby vulcanization bonding the first mounting fitting 12 to the center portion in the axis-perpendicular direction of the main rubber elastic body 16. Meanwhile, the second mounting fitting 14 is vulcanization bonded with its tapered section 30 juxtaposed against the outside peripheral face of the axial lower end of the main rubber elastic body 16, thereby vulcanization bonding the second mounting fitting 14 to the axis-perpendicular outside peripheral face of the main rubber elastic body 16. In this way, in the present embodiment the main rubber elastic body 16 is formed as an integrally vulcanization molded part 38 integrally furnished with the first mounting fitting 12 and the second mounting fitting 14.

A stopper rubber 40 is integrally formed at the axial upper end of the main rubber elastic body 16. The stopper rubber 40 is formed covering generally the entire face of the outside peripheral section of the stopper portion 20 of the first mounting fitting 12; it projects a prescribed height axially upward beyond the upper face of the stopper portion 20.

A seal rubber layer 42 is integrally formed at the axial lower end of the main rubber elastic body 16. This seal rubber layer 42 is a thin rubber layer of generally circular cylinder shape formed extending axially downward from the outside peripheral wall of the circular recess 36, and vulcanization bonded to the second mounting fitting 14 so as to cover generally the entire inside peripheral face of its cylindrical section 28. The second mounting fitting 14 is thereby covered over the entire inside face of its tapered section 30 and its cylindrical section 28 by the main rubber elastic body 16 and by the seal rubber layer 42. The seal rubber layer 42 is thin in comparison with the peripheral edge of the lower end of the main rubber elastic body 16, and forms a shoulder at the boundary between the main rubber elastic body 16 and the seal rubber layer 42.

A partition member 44 is attached in the axial lower opening section of the second mounting fitting 14, and is supported by the second mounting fitting 14. The partition member 44 has a generally circular cylindrical shape overall. In the present embodiment, it is composed of an upper plate fitting 48 of thin disk shape juxtaposed against the upper end face of a partition member body 46. In preferred practice the partition member 44 will be formed of nonmagnetized material.

The partition member body 46 is of generally circular block shape; in the present embodiment, it is formed of hard synthetic resin. On the partition member body 46 there are formed first and second mating grooves 50, 52 that open onto the outside peripheral face and extend continuously in the circumferential direction. The first mating groove 50 is spaced a prescribed distance above the second mating groove 52 in the axial direction.

At the upper end of the partition member body 46 is formed an upper circumferential slot 54 that opens onto the outside peripheral face and extends continuously for a prescribed length in the circumferential direction. At the lower end of the partition member body 46 is formed a lower circumferential slot 56 that opens onto the outside peripheral face and extends continuously for a prescribed length in the circumferential direction. In the present embodiment, the upper circumferential slot 54 is formed in a section of the partition member body 46 situated axially above the first mating groove 50, while the lower circumferential slot 56 is formed in a section of the partition member body 46 situated axially below the second mating groove 52.

The circumferential edges of the upper circumferential slot 54 and the lower circumferential slot 56 are aligned in position with one another in the circumferential direction, and are positioned so as to overlap when viewed in axial direction projection. A through-hole (not shown) extends in an axial straight line between the mutually aligned upper circumferential slot 54 and lower circumferential slot 56, passing in the axial direction between one of the circumferential edges of each. This through-hole opens at one end thereof onto the lower face of the circumferential edge of the upper circumferential slot 54, and at the other end thereof onto the upper face of the circumferential edge of the lower circumferential slot 56, so that the upper and lower circumferential slots 54, 56 communicate with each other through the through-hole. The axial upper wall of the upper circumferential slot 54 is cut away at the location where the through-hole is formed.

A lower recess 58 is formed on the lower end of the partition member body 46. The lower recess 58 is a recess of generally circular shape in cross section, and is formed so as to open axially downward in the diametrical generally center portion of the partition member body 46.

In the present embodiment, a center recess 60 is formed in the diametrical center section of the lower recess 58. The center recess 60 is a recess of circular shape in cross section and smaller in diameter than the lower recess 58 and formed so as to open axially downward at the center of the floor of the lower recess 58. In the present embodiment, due to the center recess 60 being smaller in diameter than the lower recess 58, a shoulder portion 62 is formed by the outside peripheral section of the floor of the lower recess 58. The shoulder portion 62 is formed with generally unchanging width all the way around in the circumferential direction, with the side axially above the shoulder portion 62 having a recess shape smaller in diameter in comparison to that below. Also, in the present embodiment, the lower recess 58 is formed towards the inside peripheral side away from the lower circumferential slot 56, and the center recess 60 is formed towards the inside peripheral side away from the second mating groove 52.

A through-passage hole 64 extends in the axial direction through the diametrical center section of the partition member body 46. This through-passage hole 64 is formed so as to extend in a straight line with generally unchanging cross section along the center axis of the partition member body 46, and to open respectively at its two ends onto the axial end faces of the partition member body 46. In the present embodiment, one opening of the through-passage hole 64 (the upper opening in the drawing) opens onto the center of the upper end face of the partition member body 46, while the other opening (the lower opening in the drawing) opens into the center of the upper wall of the center recess 60, so that the upper zone and the center recess 60 to either side of the partition member body 46 communicated with one another through the through-passage hole 64.

A cap fitting 66 is attached to the lower face of the partition member body 46. The cap fitting 66 is a high-rigidity component fabricated of thin steel sheet or the like, and is generally disk-shaped. In the present embodiment, the cap fitting 66 is smaller in diameter than the lower recess 58 but larger in diameter than the center recess 60. A communication hole 68 is formed in the diametrical center section of the cap fitting 66. In the present embodiment, a plurality of these communication holes 68 are formed spaced apart in the circumferential direction. A plurality of mating holes 70 are formed in the outside peripheral section of the cap fitting 66. These mating holes 70 are small circular holes, formed so as to perforate the cap fitting 66 in its thickness direction.

The cap fitting 66 is fixedly attached to the center lower end of the partition member body 46, by juxtaposing its outside peripheral section against the shoulder portion 62 situated at the boundary of the lower recess 58 with the center recess 60, and by inserting and interlocking a plurality of mating projections 72 projected axially downward from the shoulder portion 62, with the mating holes 70 which have been formed in the outside peripheral section of the cap fitting 66.

With the cap fitting 66 attached to the partition member body 46, the opening of the center recess 60 formed in the partition member body 46 will be covered by the cap fitting 66. The center recess 60 is utilized thereby to form a valve housing zone 74 in the present embodiment.

An upper plate fitting 48 is juxtaposed against the upper face of the partition member body 46. The upper plate fitting 48 is of thin, generally disk shape, and in the present embodiment is a high-rigidity component fabricated of metal material. Moreover, in the present embodiment, the outside diameter of the upper plate fitting 48 is approximately equal to the outside diameter of the partition member body 46. Furthermore, a passage hole 76 is formed in the diametrically center section of the upper plate fitting 48. The passage hole 76 is formed so as to penetrating through the upper plate fitting 48 in the thickness direction in its diametrically center section. The passage hole 76 is approximately equal in diameter to the through-passage hole 64 and is aligned in position with the through-passage hole 64. With this design, the valve housing zone 74 communicates via the communication holes 68 with a zone on the opposite side of the cap fitting 66 therefrom, and communicates via the through-passage hole 64 and the passage hole 76 with a zone on the opposite side of upper plate fitting 48 therefrom.

In the present embodiment, the partition member 44 is constituted by attaching the upper plate fitting 48 to the partition member body 46 in this way. The partition member 44 is then fitted and secured into the second mounting fitting 14. Specifically, the upper end section of the partition member 44 is inserted into the second mounting fitting 14 from below in the axial direction, and the second mounting fitting 14 is subjected to a diameter constricting process such as crimping from all sides to securely attach the partition member 44 to the second mounting fitting 14. Also, the first mating projection 34 provided on the axial lower end of the second mounting fitting 14 interlocks with the first mating groove 50 formed on the outside peripheral face of the partition member body 46, thereby securing the partition member 44 positioned in the axial direction with respect to the second mounting fitting 14.

Furthermore, in the present embodiment, a shoulder is formed in the boundary section between the lower end of the main rubber elastic body 16 and the seal rubber layer 42. The partition member 44 is positioned in the axial direction with respect to the second mounting fitting 14 through contact of the outside peripheral edge of the upper end of the partition member 44 against the shoulder from below. Also, the outside peripheral portion of the upper plate fitting 48 is positioned clamped between the partition member body 46 and the shoulder in the axial direction, whereby the upper plate fitting 48 is securely supported on the second mounting fitting 14.

The outside peripheral face of the upper end of the partition member 44 is juxtaposed fluidtightly, via the seal rubber layer 42, against the inside peripheral face of the cylindrical section 28 of the second mounting fitting 14. The opening of the upper circumferential slot 54 provided to the partition member 44 is thereby blocked off fluidtightly by the cylindrical section 28 of the second mounting fitting 14, forming an upper passage 78 of tunnel form which extends a prescribed distance in the circumferential direction.

A diaphragm 80 serving as a flexible film is disposed below the partition member 44. The diaphragm 80 is formed of a thin rubber film having ample slack, and has a generally circular dome shape. A fastener fitting 82 is vulcanization bonded to the outside peripheral edge of the diaphragm 80. The fastener fitting 82 has a thin, generally circular cylinder shape, and its upper end portion constitutes a second mating projection 84 that projects diametrically inward. The outside peripheral edge of the diaphragm 80 is vulcanization bonded to the lower end of the fastener fitting 82, and a sheath rubber 86 integrally formed with the diaphragm 80 is vulcanization bonded over its entire face to the inside peripheral face of the fastener fitting 82. As will be understood from the preceding, the diaphragm 80 in the present embodiment is formed as an integrally molded part furnished with the fastener fitting 82.

The diaphragm 80 is securely attached to the partition member 44 with the fastener fitting 82 fitted externally on the lower end of the partition member 44, and the fastener fitting 82 subjected to a diameter constricting process such as crimping from all sides. Furthermore, the second mating projection 84 provided at the upper end of the fastener fitting 82 interlocks with the second mating groove 52 provided on the outside peripheral face of the partition member 44, thereby securing the fastener fitting 82 positioned in the axial direction with respect to the partition member 44. As a result, the diaphragm 80 is disposed covering the axial lower side of the partition member 44.

In the present embodiment, the diameter constricting process of the second mounting fitting 14 and the diameter constricting process of the fastener fitting 82 are carried out simultaneously. Specifically, the integrally vulcanization molded part 38 of the main rubber elastic body 16, the partition member 44, and the integrally molded part of the diaphragm 80 are positioned with respect to one another by being set in a jig or the like; and a crimping process is carried out simultaneously on the second mounting fitting 14 in the integrally vulcanization molded part 38 of the main rubber elastic body 16 and on the fastener fitting 82 in the integrally molded part of the diaphragm 80, securing the integrally vulcanization molded part 38 of the main rubber elastic body 16 and the integrally molded part of the diaphragm 80 onto the partition member 44 in the same process.

By attaching the partition member 44 and the diaphragm 80 to the integrally vulcanization molded part 38 of the main rubber elastic body 16 in this way, a pressure receiving chamber 88 a portion of whose wall is constituted by the main rubber elastic body 16 and which gives rise to pressure fluctuations when vibration is input is formed in the axial direction between the main rubber elastic body 16 and the partition member 44 on the one hand; while an equilibrium chamber 90 a portion of whose wall is constituted by the diaphragm 80 and which readily allows changes in volume is formed in the axial direction between the partition member 44 and the diaphragm 80. A non-compressible fluid is sealed within the pressure receiving chamber 88 and the equilibrium chamber 90. In the present embodiment, the pressure receiving chamber 88 is formed by the opening of the circular recess 36 provided to the main rubber elastic body 16 being covered by the partition member 44, while the equilibrium chamber 90 is formed by the opening of the lower recess 58 provided to the partition member 44 being covered by the diaphragm 80.

Sealing of the non-compressible fluid within the pressure receiving chamber 88 and the equilibrium chamber 90 may be accomplished advantageously by carrying out assembly of the partition member 44 with the integrally vulcanization molded part 38 of the main rubber elastic body 16, and assembly of the partition member 44 with the diaphragm 80, while submerged in the non-compressible fluid, for example. The non-compressible fluid filled in pressure receiving chamber 88 and the equilibrium chamber 90 is not limited to any particular fluids; water, alkylene glycols, polyalkylene glycols, silicone oil, mixtures of these, or the like may be used favorably. Furthermore, in order to advantageously achieve vibration damping action based on flow behavior of the fluid, discussed later, it is preferable to use a low-viscosity fluid having viscosity of 0.1 Pa.s or lower.

By juxtaposing the inside peripheral face of the fastener fitting 82 against the outside peripheral face of the lower end of the partition member 44 via the sheath rubber 86, the opening at the outside peripheral side of the lower circumferential slot 56 is covered fluidtightly by the fastener fitting 82. A lower passage 92 that extends a prescribed length in the circumferential direction through the lower end portion of the partition member 44 is formed thereby.

As discussed above, the upper passage 78 and the lower passage 92 communicate with one another through a through-hole, not shown, thereby forming a tunnel-like passage extending in total a prescribed length equal to about once around in the circumferential direction.

Furthermore, one end of the tunnel-like passage communicates with the pressure receiving chamber 88 through a cutout portion 94 formed in the outside peripheral edge of the partition member body 46 and the upper plate fitting 48. The other end of the tunnel-like passage communicates with the equilibrium chamber 90 through a communication passage 96 that passes through the peripheral wall of the lower recess 58 in the diametrical direction. A first orifice passage 98 which utilizes the upper passage 78, the lower passage 92, and the through-hole (not shown) to interconnect the pressure receiving chamber 88 and the equilibrium chamber 90 is formed thereby.

A valve member 100 is positioned housed within the valve housing zone 74 which is provided to the partition member 44. The valve member 100 has a disk shape overall, and includes a valve fitting 102 serving as the valve body and a cushion rubber layer 104 affixed to the valve fitting 102. The valve member 100 is positioned on a line extended from the through-passage hole 64, and is disposed so as to spread out in axis-perpendicular direction within the valve housing zone 74.

The valve fitting 102 is a ferromagnetic body formed of magnetic material such as iron or silicon steel, having a thin, generally disk shape and outside diameter slightly smaller than the inside diameter of the valve housing zone 74. A communication window 106 serving as a communication hole of diameter approximately equal to that of the through-passage hole 64 passes in the thickness direction through the diametrical center section of the valve fitting 102. With the valve member 100 disposed in the valve housing zone 74, this communication window 106 will be situated at a location differing in the diametrical direction from those of the communication holes 68 formed in the cap fitting 66; in the present embodiment, the communication window 106 is located in the diametrical center, with the plurality of communication holes 68 situated spaced apart to the outside peripheral side so as to encircle the communication window 106, i.e. with locations and size such that the communication window 106 and the communication holes 68 do not overlap at all when the two members 102, 66 are juxtaposed as shown the drawing.

The cushion rubber layer 104 is affixed to the lower face of the valve fitting 102. The cushion rubber layer 104 has annular plate shape generally similar to the valve fitting 102, and is affixed to the lower face of the valve fitting 102 so as to cover it entirely.

The pressure receiving chamber 88 and the equilibrium chamber 90 communicate with one another through the passage hole 76, the through-passage hole 64, the valve housing zone 74, the communication window 106, and the communication holes 68; in the present embodiment, a second orifice passage 108 connecting the pressure receiving chamber 88 and the equilibrium chamber 90 is constituted by the passage hole 76, the through-passage hole 64, the valve housing zone 74, the communication window 106, and the communication holes 68.

Also, as will be apparent from the drawings, in the present embodiment, the cross sectional area of the passage hole 76, the cross sectional area of the through-passage hole 64, the cross sectional area of the communication window 106, and the total cross sectional area of the plurality of communication holes 68 are approximately identical with each other. In the present embodiment, by appropriately setting the ratio of cross sectional area of the through-passage hole 64, the communication window 106, and the communication holes 68 to the passage length of the second orifice passage 108, the tuning frequency of the second orifice passage 108 is tuned to a higher frequency band than the tuning frequency of the first orifice passage 98.

A coil spring 110 serving as urging means or a urging member is disposed in the axial direction between the partition member body 46 and the valve member 100. The coil spring 110 is disposed concentrically with the valve member 100, and in the present embodiment is installed in a pre-compressed state between the partition member body 46 and the valve member 100. Also, in the present embodiment the center portion of the lower end of the partition member body 46 projects out slightly downward, and the coil spring 110 is positioned in the axis-perpendicular direction with its upper end fitting externally onto this projecting section.

The valve member 100 is urged axially downward by the coil spring 110 installed in the above manner, and is pushed against the cap fitting 66 from above in the axial direction. From the above it will be understood that, in the present embodiment, the contacting portions of the valve body and the wall of the valve housing zone recited in the Claims are constituted by the juxtaposed portions of the valve fitting 102 and the cap fitting 66.

Since the communication holes 68 formed in the cap fitting 66 and the communication window 106 formed in the valve member 100 are provided at mutually different locations in the diametrical direction, the communication holes 68 formed in the cap fitting 66 will be closed off by the valve member 100, and the communication window 106 formed in the valve member 100 will be closed off by the cap fitting 66. Through intimate contact of the cap fitting 66 and the valve fitting 102 via the cushion rubber layer 104, the communication holes 68 and the communication window 106 are each blocked off fluidtightly.

Thus, with the coil (described later) in the non-energized state, the valve housing zone 74 and the pressure receiving chamber 88 will be separated fluidtightly by the valve member 100 and the cap fitting 66, and the second orifice passage 108 will be placed in the blocked off state. The blocked off state of the second orifice passage 108 refers to a state in which no fluid flow is produced in the second orifice passage 108.

A coil member 112 is embedded in the partition member 44. The coil member 112 includes a yoke 114, and a coil 116 wound onto the yoke 114. The yoke 114 is formed of ferromagnetic material, and is of generally cylindrical shape integrally composed of an upper floor plate of annular plate shape, an inside peripheral side wall extending upward from the inside peripheral edge of the upper floor plate, and an outside peripheral side wall extending upward from the outside peripheral edge of the upper floor plate. The coil 116 is situated between the inside peripheral side wall and the outside peripheral side wall. The coil member 112 of generally circular cylinder shape is constituted thereby.

In the present embodiment, this coil member 112 is disposed coaxially with the through-passage hole 64, and is embedded in the interior of the partition member body 46 so as to encircle the entire circumference of the through-passage hole 64. In the present embodiment, the coil member 112 is embedded internally during molding of the partition member body 46, for example, by being pre-set in the mold when the partition member body 46 is formed by means such as injection molding or the like.

Also, in the present embodiment, a lead wire 118 connected to the coil 116 is disposed extending through the interior of the partition member body 46 and leading to the outside from the outside peripheral face of the partition member body 46 which lies exposed to the outside axially between the second mounting fitting 14 and the fastener fitting 82. Furthermore, one end of the lead wire 118 is connected to the coil 116, while the other end is connected to a power unit 120. Thus, the coil 116 can be energized through the lead wire 118 from the power unit 120.

When the coil 116 is energized from the power unit 120, the magnetic force generated thereby produces attracting force which acts on the valve fitting 102 formed of magnetic material. Due to the action of the magnetic attracting force, the valve member 100 is attracted and displaced towards the partition member body 46 side, in opposition to the urging force of the coil spring 110 (see FIG. 2).

In the present embodiment, a cushion rubber 122 is disposed axially between the partition member body 46 and the valve member 100. This cushion rubber 122 is generally annular in shape and is disposed spaced peripherally outward from the coil spring 110 and extending with generally unchanging cross section all the way around the circumference thereof. In the present embodiment, the cushion rubber 122 is vulcanization bonded to the floor of the center recess 60 and projects axially downward. In the present embodiment, by providing this cushion rubber 122, the valve member 100 will be attracted and displaced towards the partition member body 46 side when the coil 116 is energized, whereupon the valve member 100 will come into cushioned contact against the partition member body 46 via the cushion rubber 122. Thus noise and impact due to contact of the valve member 100 against the partition member body 46 can be alleviated or avoided.

Through displacement of the valve member 100 in this way, the valve member 100 moves axially upward away from the cap fitting 66, thereby placing the communication holes 68 and the communication window 106 in communication and placing the valve housing zone 74 in communication with the equilibrium chamber 90 through the communication holes 68 and the communication window 106. Accordingly, with the coil 116 in the energized state, the pressure receiving chamber 88 and the equilibrium chamber 90 will communicate with each other through the second orifice passage 108.

In short, in the present embodiment, by controlling the supply of power to the coil 116, the valve member 100 can be induced to undergo displacement in the direction towards and the direction away from the cap fitting 66, making it possible to switch the second orifice passage 108 between the cutoff state and the communicating state.

The communicating state of the second orifice passage 108 refers to a state in which fluid flow can take place through the second orifice passage 108. Specifically, in the present embodiment, when vibration of the tuning frequency of the second orifice passage 108 is input, the valve housing zone 74 is placed in communication with the equilibrium chamber 90 through the opening operation of the valve member 100, whereupon the pressure receiving chamber 88 which gives rise to fluctuations of liquid pressure and the equilibrium chamber 90 which readily allows change in volume will communicate with each other through the second orifice passage 108, and fluid flow will take place through the second orifice passage 108 on the basis of the pressure differential between the pressure receiving chamber 88 and the equilibrium chamber 90. Thus, with the valve member 100 in the opened state while the coil 116 is energized, the second orifice passage 108 will be placed in the communicating state.

As will be apparent from the above discussion, in the present embodiment, valve means or a valve member is constituted so as to include the valve member 100, the coil spring 110, and the coil 116. The valve body is induced to close on the basis of elastic force exerted on the valve member 100 by the coil spring 110, and the valve body is induced to open on the basis of attraction force exerted on the valve fitting 102 by energizing of the coil 116.

In the automotive engine mount 10 pertaining to the present embodiment, when vibration is input across the first mounting fitting 12 and the second mounting fitting 14, fluid will be induced to flow through the orifice passages 98, 108 on the basis of pressure fluctuations produced in the pressure receiving chamber 88, and vibration damping action will be produced on the basis of the flow behavior of the fluid.

Specifically, in the present embodiment, during normal driving of the automobile, the external power unit 120 will not energize the coil 116, and thus the valve member 100 will be closed by the urging force of the coil spring 110, blocking off the second orifice passage 108. Therefore, fluid flow through the first orifice passage 98 will be produced effectively on the basis of the relative pressure differential between the pressure receiving chamber 88 and the equilibrium chamber 90. Excellent vibration damping action will be produced on the basis of the flow behavior, such as the resonance behavior, of fluid induced to flow between the pressure receiving chamber 88 and the equilibrium chamber 90.

In the present embodiment, the resonance frequency of fluid induced to flow through the first orifice passage 98 with the valve member 100 in the closed state is tuned to a low frequency band on the order of ten-plus Hz, so that vibration damping action based on flow behavior of fluid induced to flow through the first orifice passage 98 is effectively exhibited against vibration corresponding to engine shake of the automobile. The tuning frequency of the first orifice passage 98 can be set through proper adjustment of the ratio of passage length and passage cross sectional area.

On the other hand, when the automobile is at a stop, the coil 116 is supplied with power from the outside by the power unit 120, and due to the magnetic field generated by the coil 116 the valve fitting 102 which is fabricated of ferromagnetic material will be attracted and displaced axially upward, i.e., towards the partition member body 46 side, through the action of the magnetic force. Then, as shown in FIG. 2, the valve fitting 102 will separate upwardly in the axial direction away from the cap fitting 66, whereby the communication holes 68 formed in the cap fitting 66 and the communication window 106 formed in the valve member 100 will each be placed in communication, and the second orifice passage 108 will assume the communicating state. The pressure receiving chamber 88 and the equilibrium chamber 90 will thereby be placed in communication with each other through the second orifice passage 108. Thus, excellent vibration damping action will be produced on the basis of the flow behavior, such as the resonance behavior, of fluid induced to flow through the second orifice passage 108.

In the present embodiment, the resonance frequency of fluid induced to flow through the second orifice passage 108 is tuned to a medium- to high-frequency band on the order of between 15 and 40 Hz, so that vibration damping action based on flow behavior of fluid induced to flow through the second orifice passage 108 is effectively exhibited against vibration corresponding to medium- to high-frequency idling vibration of the automobile.

Typically, an automobile will be used for longer periods under conditions of driving than under a condition of being at a stop. Accordingly, by energizing the coil 116 at times when the automobile is at stop, as taught in the present embodiment, the duration of energization of the coil 116 can be reduced. Consequently, power consumption can be kept to a minimum, and improved mileage and reduce heat emission by the automobile can be achieved.

Moreover, in the present embodiment, when the coil 116 is not being energized, the valve fitting 102 and the cap fitting 66 come into cushioned contact via the cushion rubber layer 104. Accordingly, noise and shock can be prevented from occurring during switching from the energized state to the non-energized state. Furthermore, the cushion rubber 122 affixed to the floor of the center recess 60 is disposed between the partition member body 46 and the valve member 100, and when the coil 116 is energized, the valve member 100 comes into cushioned contact against the partition member body 46. Accordingly, noise and shock occurring during switching from the non-energized state to the energized state can be alleviated or avoided.

Also, by embedding the coil 116 in the partition member body 46, contact of the coil 116 with the fluid filled can be avoided completely. Moreover, in the present embodiment, the lead wire 118 connecting the coil 116 with the external power unit 120 is disposed extending inside the partition member body 46, and leading directly to the outside from the outside peripheral face of the partition member body 46. Accordingly, contact of lead wire 118 and the fluid filled can be advantageously prevented. Consequently, problems such as electrical leakage that could be caused by energized portions contacting the sealed non-compressible fluid can be advantageously avoided.

In the present embodiment, the valve fitting 102 is pushed against the cap fitting 66 constituting the wall surface of the valve housing zone 74 on the equilibrium chamber 90 side, thereby blocking off the second orifice passage 108. Moreover, the urging force exerted on the valve fitting 102 by the coil spring 110 is adjusted appropriately, and in the event that a high level of negative pressure has occurred inside the pressure receiving chamber 88 due to input of large-amplitude vibration, the valve fitting 102 will be moved away from the cap fitting 66 in opposition to the urging force of the coil spring 110, through the action of the negative pressure. Thus, in the event that excessive negative pressure has been produced in the pressure receiving chamber 88 due to input of a large impact load, the second orifice passage 108 will be placed in the communicating state and the negative pressure within the pressure receiving chamber 88 will be dissipated rapidly by fluid flow through the second orifice passage 108. Accordingly, noise and vibration due to cavitation, which is thought to be caused by negative pressure inside the pressure receiving chamber 88, can be advantageously prevented.

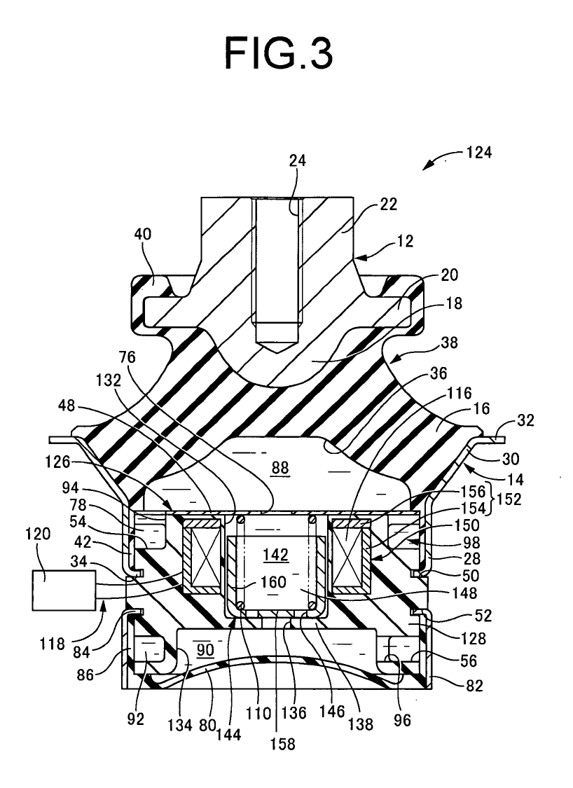

Next, an automotive engine mount 124 is shown in FIG. 3 by way of a second embodiment of the present invention. In the following description, components and parts substantially identical to those of the engine mount 10 shown in the preceding first embodiment are assigned identical symbols in the drawing and are not discussed in any detail.

Specifically, the automotive engine mount 124 pertaining to the present embodiment is furnished with a partition member 126. The partition member 126 is of thick-walled, generally circular block shape overall, and has a partition member body 128 and an upper plate fitting 48.

The partition member body 128 is a component formed of hard synthetic resin material, and has a thick-walled, generally circular block shape. An upper recess 132 which opens axially upward is formed in the diametrical center section of the partition member body 128. In the present embodiment, the upper recess 132 is a deep circular recess and extends in the axial direction with a generally unchanging cross section.

A lower recess 134 is formed in the lower end of the partition member body 128. The lower recess 134 is a recess of generally unchanging circular cross section, and is formed so as to open axially downward in the diametrical center section of the partition member body 128. The upper recess 132 and the lower recess 134 are formed spaced apart by a prescribed distance in the axial direction; in the present embodiment, the upper recess 132 is smaller in diameter and deeper than the lower recess 134.

A through-passage hole 136 which serves as a communication hole in the present embodiment is formed in the diametrical center section of the partition member body 128. This through-passage hole 136 extends in the axial direction with generally unchanging circular cross section, with the upper recess 132 and the lower recess 134 communicating with each other by the through-passage hole 136.

The upper plate fitting 48 is fabricated of iron, aluminum alloy, or other metal material, and has a thin, generally disk shape. Its diametrical center portion is perforated by a passage hole 76 formed in the thickness direction. This passage hole 76 is a circular hole formed in the diametrical center portion of the upper plate fitting 48, and perforates the upper plate fitting 48 in its thickness direction.

The partition member 126 is constituted by juxtaposing the upper plate fitting 48 against the partition member body 128 from above. With the partition member body 128 and the upper plate fitting 48 in the assembled state, the opening of the upper recess 132 formed in the partition member body 128 is covered by the upper plate fitting 48, and the upper recess 132 is utilized to form a valve housing zone 142.

This partition member 126 is secured with its upper end section inserted into the second mounting fitting 14, and to its lower end section is attached a diaphragm 80. Thus, a pressure receiving chamber 88 is formed axially above the partition member 126, and an equilibrium chamber 90 is formed below. In the present embodiment, the valve housing zone 142 communicates with the pressure receiving chamber 88 through the passage hole 76 formed in the upper plate fitting 48, and communicates with the equilibrium chamber 90 through the through-passage hole 136 formed in the partition member body 128.

A valve fitting 144 provided as a valve body is housed within the valve housing zone 142. The valve fitting 144 is a ferromagnetic body formed of magnetic material such as iron, and has a generally bottomed circular cylinder shape overall. The outside diameter of the valve fitting 144 is slightly smaller than the inside diameter of the valve housing zone 142, providing a gap between the outside peripheral face of the valve fitting 144 and the inside face of the side wall of the valve housing zone 142.

Communication windows 146 serving as communication holes are formed in the floor of the valve fitting 144 constituting the plate shaped portion in the present embodiment. A plurality of the communication windows 146 are disposed spaced apart by prescribed intervals in the circumferential direction and passing through the floor of the valve fitting 144 in the thickness direction, i.e. the axial direction. Furthermore, with the valve fitting 144 installed in the valve housing zone 142, the communication windows 146 formed in the valve fitting 144 will be situated at different locations in the diametrical direction from the through-passage hole 136 which is formed in a wall of the valve housing zone 142, in the form of an abutting plate portion 138 of the partition member body 128. In the present embodiment, the opening of the through-passage hole 136 is formed in the approximate diametrical center, while the plurality of communication windows 146 are situated spaced apart to the outside peripheral side so as to encircle the through-passage hole 136.

In the present embodiment, the pressure receiving chamber 88 and the equilibrium chamber 90 communicate with each other through the passage hole 76, the valve housing zone 142, the communication windows 146, and the through-passage hole 136. The second orifice passage 148 in the present embodiment is constituted by the passage hole 76, the valve housing zone 142, the communication windows 146, and the through-passage hole 136 which are formed axially between the pressure receiving chamber 88 and the equilibrium chamber 90.

In the present embodiment, the cross sectional area of the passage hole 76, the total cross sectional area of the communication windows 146, and the cross sectional area of the through-passage hole 136 are approximately equal; by adjusting the ratio of cross sectional area of the passage hole 76, the communication windows 146, and the through-passage hole 136 to the passage length of the second orifice passage 148, the tuning frequency of the second orifice passage 148 is tuned to a frequency corresponding to idling vibration, lying in a higher frequency band than the tuning frequency of the first orifice passage 98.

A coil spring 110 is installed in the valve fitting 144 of bottomed circular cylinder shape. In the present embodiment, the coil spring 110 is inserted within a peripheral wall 160 of the valve fitting 144, with the coil spring 110 pre-compressed by a prescribed amount and interposed between axially opposed faces of a floor 158 of the valve fitting. 144 and the upper plate fitting 48.

By installing the coil spring 110 between the valve fitting 144 and the upper plate fitting 48 in this way, with the coil (discussed later) in the non-energized state, the valve fitting 144 will be urged axially downward by the elastic force of the coil spring 110, pushing the floor 158 of the valve fitting 144 from above against the abutting plate portion 138 of the valve housing zone 142. The floor 158 of the valve fitting 144 will then be pushed against the abutting plate portion 138 of the valve housing zone 142, whereby the through-passage hole 136 will be blocked off by the valve fitting 144, and the communication windows 146 will be blocked off by the outside peripheral section of the abutting plate portion 138 of the valve housing zone 142. Thus, with the coil in the non-energized state, the second orifice passage 148 will be placed in the cutoff state.

A coil member 150 is embedded in the partition member 126. The coil member 150 includes a yoke 152 and a coil 116. The yoke 152 is formed of magnetic material, and is constructed of an upper yoke fitting 156 of annular plate shape attached from above to a lower yoke fitting 154 of generally bottomed circular cylinder shape provided with a floor of annular plate shape. The coil member 150 is constituted by installing the coil 116 between the opposed faces of the floor of the lower yoke fitting 154 and the upper yoke fitting 156.

The coil member 150 of the structure described above is installed in the interior of the partition member body 128. Specifically, the coil member 150 is installed encircling the outside peripheral side of the valve housing zone 142. In the present embodiment, as in the preceding first embodiment, the coil member 150 is embedded during the process of molding the partition member body 128.

The yoke 152 is magnetized through the action of a magnetic field generated in the coil 116 when power is supplied to the coil 116 from an external power unit 120. Then, the upper end of the valve fitting 144, which is fabricated of magnetic material, is attracted by the, magnetized upper yoke fitting 156, thereby attracting and displacing the valve fitting 144 axially upward. Through displacement of the valve fitting 144 in this way, the floor of the valve fitting 144 will move upwardly away from the floor of the valve housing zone 142, placing the communication windows 146 formed in the valve fitting 144 and the through-passage hole 136 formed in the partition member body 128 in the communicating state. Thus, with the coil 116 in the energized state, the second orifice passage 148 will be placed in the communicating state. Consequently, with the coil 116 in the energized state, the pressure receiving chamber 88 and the equilibrium chamber 90 will communicate with each other through the second orifice passage 148.

The automotive engine mount 124 having structure in accordance with this embodiment affords effects similar to those of the automotive engine mount 10 shown in the previous first embodiment. Specifically, by controlling energization of the coil 116 and opening or closing the valve fitting 144 according to the driving condition of the vehicle or the like, it is possible to achieve effective vibration damping action against input of engine shake, medium- to high-frequency idling vibration, or low-frequency idling vibration.

Moreover, in the present embodiment as well, since the coil 116 is energized at times that the vehicle is at a stop, energization time can be relatively short, and advantages such as reduced power consumption and improved mileage may be advantageously achieved.

Also, in the present embodiment as well, in the event that excessive negative pressure arises in the pressure receiving chamber 88 due to input of a large impact load, the valve fitting 144 will separate away from the floor of the valve housing zone 142 due to the pressure differential between the pressure receiving chamber 88 and the equilibrium chamber 90 and place the second orifice passage 148 in the communicating state, whereby the negative pressure within the pressure receiving chamber 88 will be dissipated rapidly by fluid flow through the second orifice passage 148. Accordingly, noise and vibration due to cavitation, which is thought to be caused by negative pressure inside the pressure receiving chamber 88, can be alleviated or avoided.

While the present invention has been shown hereinabove through certain preferred embodiments, these are merely exemplary and should not be construed as limiting the invention in any way to the specific disclosure of the embodiments herein.

For example, the valve body should not be construed as being limited to those taught in the first and second embodiments above.

For example, whereas in the first and second embodiments hereinabove the coil 116 was embedded in a partition member body 46 (128) which constitutes the partition member 44 (126), the coil 116 need not necessarily be embedded in the partition member body 46 (128) and may instead be installed in the interior of the partition member 44 (126). Specifically, a recess for installation of the coil 116 may be formed in the partition member, and the coil 116 then installed in the recess, while also providing a cap member to cover fluidtightly the opening of the recess, thereby installing the coil 116 in the interior of the partition member.

Also, whereas in the first and second embodiments hereinabove, a yoke 114 (152) formed of ferromagnetic material was positioned about the coil 116, a yoke is not always necessary, and it would be acceptable, for example, to attach the coil 116 to a bobbin formed of nonmagnetic synthetic resin material, and installed in this state in the partition member.

Moreover, the structures of the first and second mounting fittings 12, 14, of the partition member 44 (126), and so on should not be construed as being limited to those taught in the first and second embodiments hereinabove. For example, the partition member 44 (126) need not always be disposed with part of its outside peripheral face exposed to the outside, and could instead by attached to the second mounting fitting 14 by being press-fit in the inside peripheral side of the cylindrical second mounting fitting 14.

It is also to be understood that the present invention may be embodied with various other changes, modifications and improvements, which may occur to those skilled in the art, without departing from the spirit and scope of the invention defined in the following claims.

What is claimed is:

1. A fluid filled type engine mount comprising:
a first mounting member fixable to one of a power unit and a vehicle body;
a second mounting member mounted on an other of the power unit and the vehicle body;
a main rubber elastic body elastically connecting the first mounting member and the second mounting member;
a partition member supported by the second mounting member;
a pressure receiving chamber whose wall is partially constituted by the main rubber elastic body and having a non-compressible fluid filled therein;
an equilibrium chamber whose wall is partially constituted by a, readily deforming, flexible film and having the non-compressible fluid filled therein, the chambers being formed respectively to either side of the partition member;
a first orifice passage and a second orifice passage respectively connecting the pressure receiving chamber and the equilibrium chamber to each other, with the second orifice passage being tuned to a higher frequency band than the first orifice passage; and
a valve member actuated by energization from an outside, with the second orifice passage being switchable between a communicating state and a cutoff state by the valve member,
wherein the partition member is furnished with a valve housing zone along a fluid passage through the second orifice passage, and a valve body composed of ferromagnetic material is housed displaceably within the valve housing zone; an urging member is provided for urging the valve body towards a displacing end situated towards the equilibrium chamber; the valve member includes a coil disposed about the valve body in the partition member and energizing the coil to urge the valve body towards the pressure receiving chamber in opposition to urging force; communication holes are formed respectively at mutually non-overlapping locations in contacting portions of the valve body and a wall of the valve housing zone urged into contact with one another by the urging force of the urging member; and the second orifice passage is placed in the cutoff state through juxtaposition of the contacting portions of the valve body and the wall of the valve housing zone by the urging force of the urging member, blocking off the communication holes, while the second orifice passage is placed in the communicating state through energization of the coil to separate the contacting portions of the valve body and the wall of the valve housing zone, unblocking the communication holes.

2. The fluid filled type engine mount according to claim 1, wherein the valve body has a bottomed circular cylinder shape, with a floor of the valve body constituting the contacting portion positioned in contact against the wall of the valve housing zone, and with the communication hole formed in the floor of the valve body.

3. The fluid filled type engine mount according to claim 2, wherein the urging member comprises a coil spring that is positioned with one end thereof inserted within a peripheral wall of the valve body and positioned in contact with the floor of the valve body.

4. The fluid filled type engine mount according to claim 1, wherein the communication hole in the contacting portion of the valve body and the communication hole in the contacting portion of the wall of the valve housing zone are disposed at mutually different locations in a direction orthogonal to the direction of contact of the valve body with the wall of the valve housing zone.

5. The fluid filled type engine mount according to claim 1, wherein pressure of the pressure receiving chamber is exerted on one face of the valve body while pressure of the equilibrium chamber is exerted on an other face of the valve body through the communication hole provided in the wall of the valve housing zone so that, during input of vibration, negative pressure generated in the pressure receiving chamber urges the valve body in opposition to urging force of the urging member to move it away from the wall of the valve housing zone and place the communication holes in the communicating state.

6. The fluid filled type engine mount according to claim 1, wherein the first orifice passage is tuned to a frequency band which corresponds to engine shake, and the second orifice passage is tuned to a frequency band which corresponds to idling vibration in order to provide an engine mount for an automobile.

7. The fluid filled type engine mount according to claim 1, wherein the valve body has a disk shape, with a bottom wall of the valve body constituting the contacting portion positioned in contact against the wall of the valve housing zone via a cushion rubber layer.

8. The fluid filled type engine mount according to claim 7, wherein the urging member comprises a coil spring that is positioned disposed in the axial direction between an upper wall of the valve housing zone and the valve body that is located underneath the coil.
